(19) United States
(12) Patent Application Publication
(10) Pub. No.: US 2008/0288985 A1
(43) Pub. Date: Nov. 20, 2008

(54) Optimally Selecting Partial Tv Programs

(75) Inventors: Wilhelmus Franciscus Johannes Verhaegh, Eindhoven (NL); Johannes Henricus Maria Korst, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 12/092,890

(22) PCT Filed: Nov. 6, 2006
(86) PCT No.: PCT/IB06/54127

§ 371 Date: May 7, 2008

Related U.S. Application Data
(60) Provisional application No. 60/735,927, filed on Nov. 10, 2005.

(51) Int. Cl. G06F 3/00; H04N 7/173

(52) U.S. Cl. 725/58; 725/39; 725/131

(57) ABSTRACT

A system (600), apparatus (500), and method are provided to select a best set of TV programs for reception and recording by at least one tuner said TV programs being broadcast during a given time period [b, e] having a beginning time b and an ending time e. Partial and entire TV programs are considered and for each partial or entire TV program a user preference value is provided for its reception and recording. A minimum-cost network algorithm is used that solves the selection and viewing problem to optimality (guaranteed).

The present invention relates to a system, apparatus and method that is guaranteed to make optimal selections of partial TV programs to be recorded using a limited number of tuners during a given time interval. A part is defined as some or all of a TV program.

Personal video recorders (PVRS) are available to record TV programs, either on hard disk or on DVD. Programming these PVRs is usually accomplished using an electronic program guide (EPG), by simply clicking on the TV programs to be recorded. Additionally, a recommender may be available that can predict, for an upcoming TV program, how much a viewer will like it.

With the increasingly available television channels via terrestrial, satellite, or cable connections, the task for the viewer to select TV programs to view and record is rapidly becoming too large to be handled manually. With the advent of digital television, the number of channels, and hence the number of options, to choose from is becoming even larger. Therefore, the viewer is no longer able to overview all available programming content and it becomes more likely that the viewer will miss TV programs that would be of interest to the viewer.

Because of the large number of TV programs available each week, printed TV program guides are cumbersome and electronic program guides (EPGs) have been developed as a solution to this problem. EPGs present the available TV programs for a number of channels on a TV screen. However, only a limited number of TV programs can be shown at one time on the TV screen, i.e., the number of channels and the length of the time interval of the portion shown on the screen are very limited. This results from the poor resolution of a TV screen for presentation of this kind of textual information. And, even if the resolution were high enough, the task of selecting from the very large amount of available TV content would overwhelm the average viewer.

In order ameliorate the viewer's problem of what TV programs to select and when to watch them, i.e., the problem of developing a viewer-specific viewing schedule, EPGs offer an option of searching (filtering) by keyword(s). In this way EPGs reduce the number of TV programs to be screened and selected by the viewer to a manageable number. Another way for the viewer to cull a plurality of uninteresting-to-the-viewer TV programs is through the use of recommender systems based on artificial intelligence (AI) technology. These AI recommender systems maintain a preference profile of the viewer, indicating what the viewer likes and dislikes, and employ this profile to score each newly offered TV program as to what extent the viewer will like the newly offered TV program. Then, the TV programs scoring in excess of a pre-determined viewer-specific tolerance are highlighted in an EPG or the viewer is provided a list of these TV programs. A problem with these solutions, however, is that they do not take into account whether or not TV programs overlap in time, so it remains for the viewer to compile a viewer-specific schedule of top-scoring TV programs to watch during, e.g., an evening. In other words, whereas filters and recommenders come up with a list of individual TV programs, such a list is an incomplete solution to a viewer's problem of creating a schedule of TV programs to watch.

A similar situation exists for recording TV programs.

A solution is needed for efficient selection of TV programs for a given time interval that maximizes predetermined viewer preferences when the viewer has only a finite number M≧1 of tuners available with which to record selected TV programs.

The system, apparatus, and method of the present invention provide an efficient algorithm that is guaranteed to make optimal selections of partial TV programs with a limited number of tuners, i.e., a selection that maximizes a sum of the viewer preference values associated with the selected TV programs. It is assumed that these preferences are known to, e.g., a recommender that provides a first filtering of available TV programs before an optimal selection is made using the present invention.

Given a time interval in which a viewer wants to select TV programs, all TV programs that fall in this interval are first collected and a preference value for each collected TV program is obtained. Second, the begin and end time points of each TV program are determined as nodes of a directed graph G and a set S is determined of TV programs having at least one of a begin and end time point within the given time interval. Third, a time 0 source and a time ∞ sink node are created and a graph of G is drawn from the source through the successive time-ordered nodes of G to the sink, i.e., a central time chain of edges is created from the source node through each successive time-ordered node of G, wherein, each edge has a cost of 0′.

Next, for each TV program in S a kind of time chain is drawn in order to distinguish between the central time chain of edges and the node corresponding to its begin time and the node corresponding to its end time and this edge is given a ‘cost’ equal to the negated value of the TV program (viewer preference value).

Then, in addition to the nodes already included in the central timeline, each TV program in S is further divided into zero or more partial TV programs represented by begin and end node pairs on the central timeline having edges therebetween not on the central timeline such that it is possible for every TV program only to start being received at its begin time or at the end time of another TV program, and such that every TV program stops being received at its end time or at the begin time of another TV program. Every such partial TV program resulting is added to S and has an associated viewer preference value determined by a viewer-specific value function. As shown below in the detailed description, no loss of optimality results from this restriction (see Theorem 1 below).

Key in the present invention is thus the graph G comprising the central time chain, from and to which the whole and partial TV program edges run, which edges represent the negative preference value of these whole and partial parts of the TV programs and which whole and partial parts are contained in the set S.

Given this directed graph G, a minimum-cost network algorithm is applied thereto that determines the subset of partial TV programs S′, for the given time interval, that provides the maximum viewer satisfaction, i.e., maximizes the total of viewer preference values for the set S of TV programs. The selected subset is guaranteed to be optimal and the algorithm selecting the subset is guaranteed to run in polynomial time.

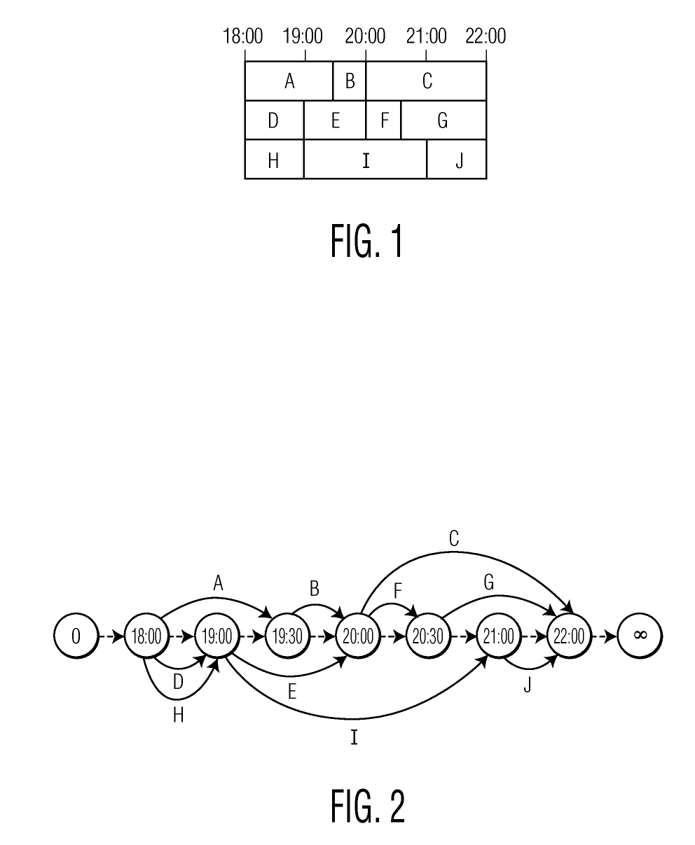

FIG. 1 illustrates a number of TV programs offered over time t;

FIG. 2 illustrates a directed graph for the TV programs of FIG. 1;

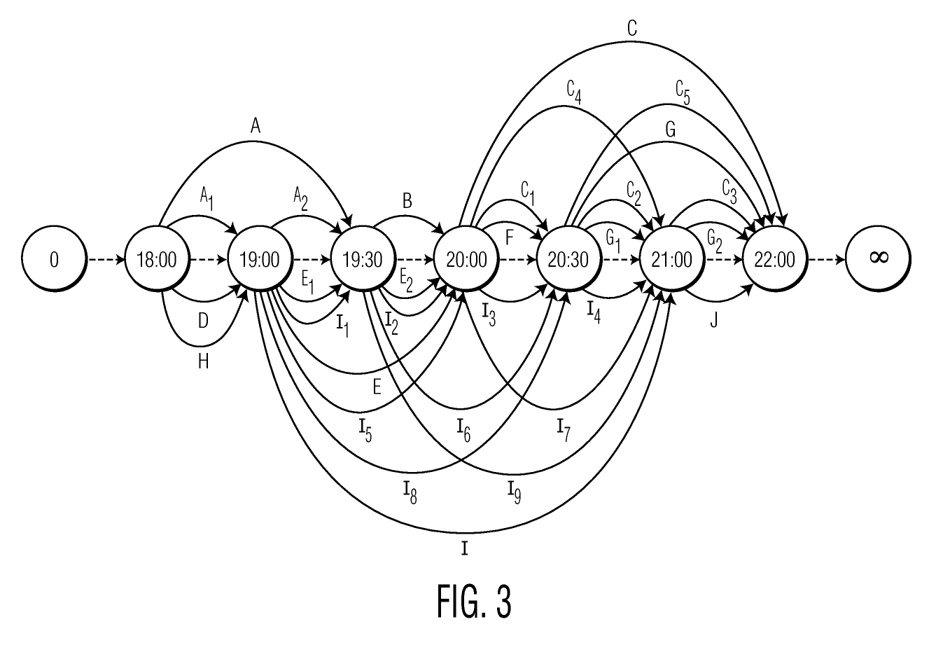

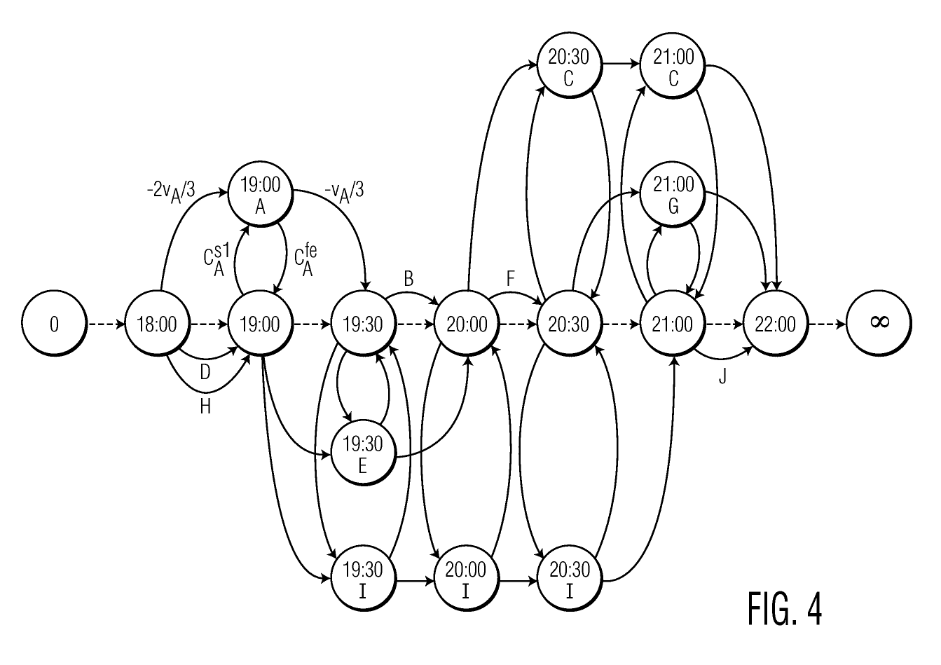

FIG. 3 illustrates an extended graph for the example of FIG. 1 that includes partial TV programs;

FIG. 4 illustrates an extended graph for the example of FIG. that includes partial TV programs with value functions that are linear with penalties and costs of related edges for TV program A;

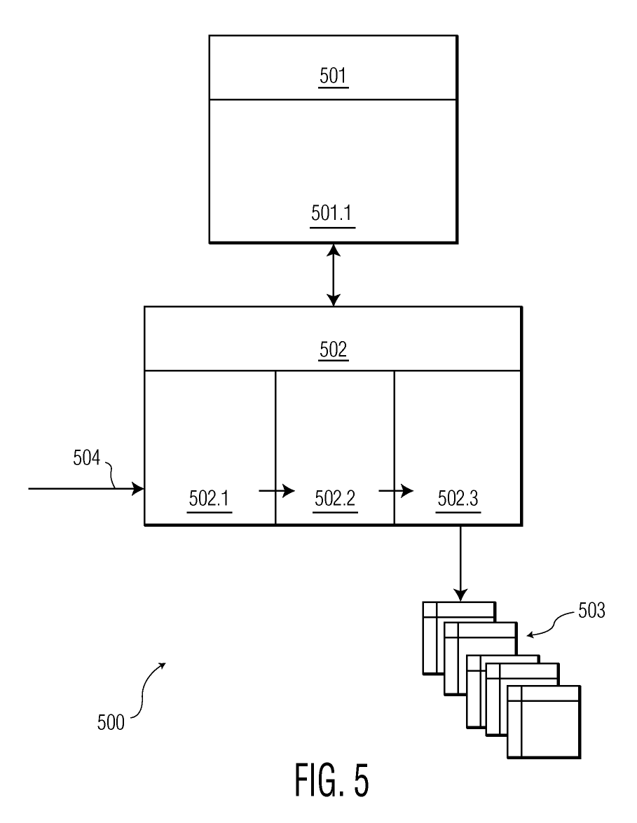

FIG. 5 illustrates an apparatus for performing the method of optimal selection of partial TV programs according to the present invention; and

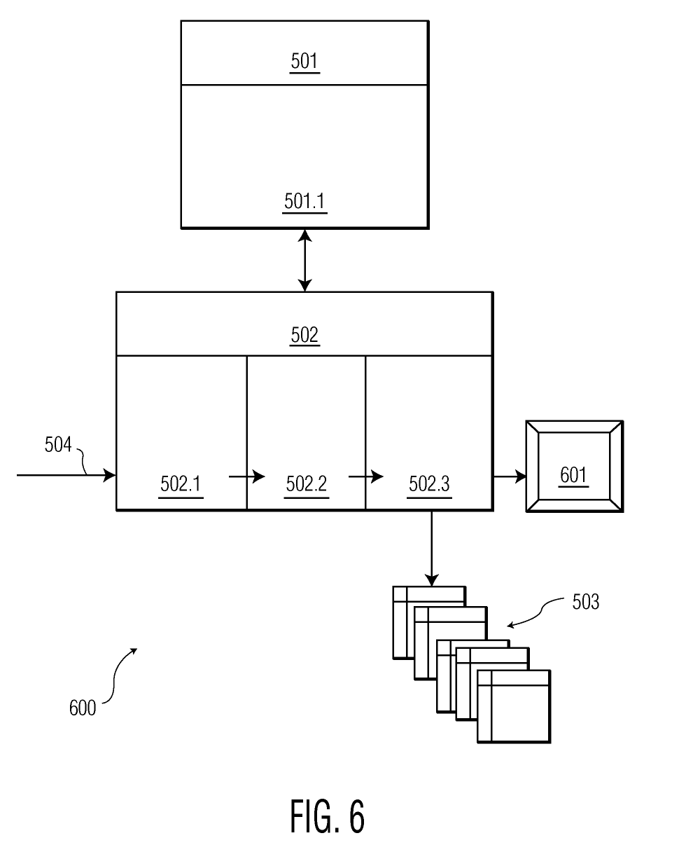

FIG. 6 illustrates a system for receiving, recording and displaying a set of partial TV programs selected in accordance with the present invention.

The system, apparatus, and method of the present invention provide a way of determining an optimal TV experience for a viewer for a given time interval, the experience comprising watching as well as recording partial preferred TV programs using at least one tuner.

The system, apparatus, and method of the present invention provide a mathematical formulation and solution strategy for obtaining an optimal solution to a viewer's TV program scheduling problem. The scope of the system, apparatus, and method of the present invention includes the problem of what TV programs to select for watching or recording with a given number of available tuners based on a pre-determined viewer preference for all available TV programs being broadcast in given time period.

A simplified problem setting is described first followed by an extension of the simplified problem setting to include more factors and to elaborate the algorithms developed for the simplified problem, in order to solve more complex problem settings.

In a preferred embodiment of the system, apparatus, and method of the present invention, several assumptions are first made:
1. a preference value or score is provided for each of a plurality of candidate TV programs, indicating how much a viewer prefers the candidate TV program;
2. each preference score is given explicitly by the viewer or by a recommender tool;
3 the total preference score for a number of TV programs being selected is given by a linear sum of the provided preference scores of the individual TV programs; and
4. TV programs that are selected for watching are assumed to be watched at the very moment they are broadcast; if a TV program is watched later, it is simply assumed to be recorded during its broadcast.
   Each of the simplified and extension thereof are modeled as a directed graph to transform the problem into a minimum-cost network flow problem. Since minimum-cost network flow problems can be solved in polynomial time, the corresponding TV program selection problem can be solved efficiently.

The first model selects complete TV programs using one tuner. The problem of selecting complete TV programs is defined as follows.

Definition 1 (Program selection problem (PSP)). A set S of TV programs s is given and for each TV program s a begin time b, and end time eₛ is also specified. Furthermore, for each TV program a value vₛ>0 is given, which reflects the total value if this TV program is watched (completely). The question is to determine a subset S′⊂S such that the TV programs in S′ do not conflict in time, i.e.,

bₛ>eₜVb^{t}>eₛ

for all s, tεS′, s≠t, and such that the total value of this subset, given by

$${\sum }_{s ∈ {S}^{′}} {v}_{s}$$

is maximized.

The value vₛ of a TV program can be given by the viewer explicitly, or it can be estimated using a recommender. Considering the recommender score pₛ of a TV program s as a preference density, the total value is given by vₛ=pₛ(eₛ−bₛ). Maximizing the total value over a number of TV programs in a certain time interval then corresponds to maximizing the average preference density.

The TV program selection problem can be formulated as a minimum-cost flow problem as follows. The set V of nodes of a network G is given by a source node and a sink node, and a node for each begin or end time of a TV program. So,

$$V = \{ 0 , ∞ \} ⋃ {⋃}_{s ∈ S} \{ {b}_{s} , {e}_{s} \} ,$$

where the node 0 represents the source and cc represents the sink. Denoting the nodes (i.e., times) in V by t₁, . . . , tₙ the n distinct times can then be arranged in increasing order. Here, it is assumed that all times are larger than the source time t₁=0, and smaller than the sink time tₙ=∞.

The set E of edges consists of two parts. First, there is an edge on a timeline from source to sink that includes the node edge (tᵢ, tᵢ₊₁) for all i=1, . . . , n−1, having zero cost, by definition. Secondly, for each TV program sεS, an edge (bₛ, eₛ) is added, with cost −v_{S}. All edges are assumed to have capacity one.

For an example of the graph construction, consider the set of TV programs as indicated in FIG. 1, covering TV programs A, B, . . . , J in a time interval from 18:00 h to 22:00 h. The corresponding set V of time points is given by

F={0,18:00,19:00,19:30,20:00,20:30,21:00,22:00,∞},

and the set of edges is as given in FIG. 2.

Now, determining a non-overlapping subset S′ with maximal value corresponds to finding a flow of one in G from the source to the sink with minimum cost. If in this minimum-cost flow an edge corresponding to a TV program carries a flow of one, then this TV program can be included in S′; otherwise not. Hence, the problem can be solved by means of a minimum-cost flow algorithm. In other words, PSP can be solved efficiently.

As in the above formulation all capacities are one, the minimum-cost flow problem reduces to a shortest-path problem (from source to sink), where the (negative) costs are used as edge lengths.

The min-cost flow problem: Given a directed graph G=(V, E). Let there be a cost cᵢⱼ and capacity uᵢⱼ=1, associated with each edge ij in E, and a demand (supply) bᵥ associated with each node v in V. The problem is to find a flow of minimum cost which satisfies the supply/demand constraints for each node,

bᵥ=Σⱼfᵥⱼ−Σⱼfⱼᵥ

and the edge constraints,

0≦fᵢⱼ≦uᵢⱼ.

The cost of the flow is defined as

Σ_{ijεE}cᵢⱼfᵢⱼ.

In the present invention, the capacity of each edge is 1, by definition. Furthermore, b₁=−1, bₙ=1, and bᵢ=0 for i=2, . . . , n−1.

Multiple TV programs can be received in parallel whenever more than one tuner is available, and the additionally selected TV programs are recorded. The problem is also relevant in a two-stage TV programming approach, where one first determines what TV programs to receive, which are then stored in a persistent memory, and then determines a TV schedule from all content that has been recorded in the persistent memory.

Definition 2 (Multi-tuner program selection problem (MPSP)). Given is a set S of TV programs and for each TV program s a begin time bₛ, an end time eₛ, and a value vₛ are given. Furthermore, a pre-determined number M of tuners is also given. The question is to determine a subset S′⊂S such that at all times at most M TV programs have been selected, i.e., for all times x

|{sεS′|bₛ≦x<eₛ}|≦M,

and such that the total value of this subset, given by

$${\sum }_{s ∈ {S}^{′}} {v}_{s}$$

is maximized.

MPSP is solved in a similar way as PSP, using an equivalent network flow transformation as presented above. The only difference is that for MPSP the capacities of the edges (tᵢ,tᵢ₊₁) are changed into M to reflect the availability of M tuners; the capacity of the TV program edges remains one, as it is not desirable for a program to be received multiple times.

Next, a minimum-cost flow of M from source to sink is determined, and again each TV program for which the corresponding edge in the graph carries a flow (of one) in this found minimum-cost flow solution is included in S′.

In a first embodiment, the present invention extends the above-described single tuner solution for complete TV programs to include watching some TV programs only partially. To this end, a value function vₛ(l, r) is introduced for each TV program s that indicates the value for watching the program during the partially open interval [l, r), with bₛ≦1≦r≦eₛ. For this value function, it is assumed that

vₛ(bₛ,eₛ)=vₛ,vₛ(l₁,r₁)>vₛ(l₂,r₂) if [l₁,r₁)⊃[l₂,r₂), and vₛ(x,x)≦0.

Definition 3 (Partial program selection problem (PPSP)). Given is a set S of TV programs, and for each TV program s a begin time bₛ and end time eₛ. Furthermore, for each TV program a value function v, is given. The question is to determine for each TV program sεS a (possibly empty) set Iₛ={[l₁, r₁), . . . , [lₖ_{ₛ}, rₖ_{ₛ})}) of intervals during which to watch it, with

bₛ≦l₁<r₁<l₂<r₂< . . . <lₖ_{ₛ}<rₖ_{ₛ}≦eₛ, such that the selected intervals of the TV programs do not conflict in time. This means that for all s,tεS′,s≠t, and for all [l,r)εI_{S},[l′,r′)εIₜ we have l≧r′vl′≧r, i.e., any interval of s is either later than any interval of t, or vice versa. Note that it is allowed that one interval starts exactly at the same moment that another one ends, as we used half-open intervals. The objective is that the total value of the selected intervals, given by

$${\sum }_{s ∈ S} {\sum }_{[ l , r ) ∈ {I}_{s}} {v}_{s} ( l , r ) ,$$

is maximized.

Although the value function can be of almost any form, in a preferred embodiment it is restricted to convex value functions, which are discussed in the next section. An even more restricted form, which can be handled more efficiently, is a linear value function with penalties, also discussed below.

Convex Value Functions

Convex value functions are value functions v that satisfy the condition that for all αε[0,1] the following holds

v(αl₁+(1−α)l₂,αr₁+(1−α)r₂)<αv(l₁,r₁)+(1−α)v(l₂,r₂).

Most practical value functions will satisfy this condition. Example convex value functions are linear functions such as

$${v}_{s} ( l , r ) = {v}_{s} \frac{r - l}{{e}_{s} - {b}_{s}} ,$$

or quadratic functions such as

$${v}_{s} ( l , r ) = {{v}_{s} ( \frac{r - l}{{e}_{s} - {b}_{s}} )}^{2} .$$

One of the properties of a convex value function is that it allows reduction of the number of possible points at which to switch from one TV program to another, as the next theorem states.

Theorem 1. If for all TV programs sεS, vₛ(l, r) is convex, then, without loss of optimally, PPSP can be restricted to solutions with for all sεS and [l, r)εIₛ

lε{bₛ}∪{eₜ|tεS} (1)

eε{eₛ}∪{bₜ|tεS} (2)

In other words, a TV program only starts being received at its begin time or at the end time of another TV program, and it only stops being received at its end time or at the begin time of another TV program.

Proof. Consider an interval [l, r)εIₛ of a TV program sεS that does not satisfy (1). Just before time l, the maximum number of tuners must have been used, as otherwise it would be possible to lower l and improve the solution. As reception of TV program s occurs from time l onwards, there must be a TV program tεS that stops being received at time l, i.e., for which Iₜ contains an interval [l′, r′) with r′=l. Because l does not satisfy (1), r′<eₜ. Now consider two alternative solutions, one with l replaced by l₁=l−ε and r′ replaced by r₁′=r′−ε=l₁, and one with l replaced by l₂=l+ε and r′ replaced by r′₂=r′+ε=l₂ Compared to the original solution, the cost of the first solution differs an amount

Δ₁=vₛ(l−ε,r)−vₛ(l,r)+vₜ(l′,r′−ε)−vₜ(l′,r′)

from the value of the original solution, and the cost of the second one differs by an amount

Δ₂=vₛ(l+ε,r)−vₛ(l,r)+vₜ(l′,r′+ε)−vₜ(l′,r′).

Therefore, it follows that

$$\frac{{Δ}_{1} + {Δ}_{2}}{2} = \frac{\begin{matrix}{v}_{s} ( l - ɛ , r ) + \\ {v}_{s} ( l + ɛ , r )\end{matrix}}{2} - {v}_{s} ( l , r ) + \frac{\begin{matrix}{v}_{t} ( {l}^{′} , {r}^{′} - ɛ ) + \\ {v}_{t} ( {l}^{′} , {r}^{′} + ɛ )\end{matrix}}{2} - {v}_{t} ( {l}^{′} , {r}^{′} ) \geq 0 + 0 = 0$$

where the latter inequality is based on the convexity property of vₛ and vₜ. Hence, at least one of the differences Δ₁ and Δ₂ is non-negative, i.e., at least one of the two alternative solutions is at least as good as the original one. So, without loss of optimality, on can either increase l and r′ until they become eₜ or r (in the latter case the interval [l, r] can be removed from Iₛ), or one can decrease l and r′ until they become bₛ, or l′ (in the latter case [l′, r′) can be removed from Iₜ).

In a similar way one can prove that (2) can be assumed without loss of optimality.

As a result of Theorem 1, it is only necessary to consider a limited number of time points at which to start and stop watching a TV program partially, provided the value functions are convex. Based on this, the minimum-cost network of FIG. 2 can be extended as shown in FIG. 3. The costs for the TV program edges are determined by the value for the corresponding part of the TV program. An optimal flow in the extended graph now corresponds to an optimal solution of PPSP. In such a flow, multiple edges per program may be used, which corresponds to receiving the TV program during multiple intervals. For instance, an optimal flow might run through edges I₁ and I₇ in the extended graph, meaning that TV program I is selected from 19:00-19:30 and from 20:00-21:00. As there is only a flow of one, the same time interval is never covered twice. Furthermore, selecting two consecutive parts is at most as good as selecting the combined part (e.g. choosing I₅ is at least as good as choosing I₁ and I₂), hence adjacent intervals can be merged (and are automatically merged if that is strictly better).

Although the number of edges in the extended graph is much larger than in the original graph, it is still polynomially bounded. More precisely, the number of edges per TV program is quadratic in the number of different time points. Furthermore, since there is only one tuner, the number of edges can be limited between each pair of time points to only the best one, thereby limiting the total number of edges to O(n²).

Linear Value Functions with Penalties

In this alternative embodiment the form of the value functions is restricted even further, to linear functions with penalties for finishing a TV program early or starting a TV program late. More formally, consider value functions of the form

$${v}_{s} ( l , r ) = {v}_{s} \cdot \frac{r - l}{{e}_{s} - {b}_{s}} - {p}_{s}^{fe} ( r ) - {p}_{s}^{s 1} ( l ) , \\ where \\ {p}_{s}^{fe} ( r ) = \{ \begin{matrix}0 & if r = {e}_{s} \\ {c}_{s}^{fe} & if r < {e}_{s}\end{matrix} \\ {p}_{s}^{s 1} ( l ) = \{ \begin{matrix}0 & if l = {b}_{s} \\ {c}_{s}^{s 1} & if l > {b}_{s}\end{matrix} \qquad ( 3 )$$

are functions that give a penalty if TV program s is finished early or started late, respectively. Note that this value function obeys the assumptions and that it is convex, as all three terms in the right-hand side of (3) are convex (i.e., the penalty functions are concave). Given a value function as in (3), we can define another extended minimum-cost network, as shown in FIG. 4. More formally, this graph is constructed as follows.

The set V of nodes first of all contains a node for each time point t₁, . . . , tₙ. Next, for each TV program with time points bₛ=tᵢ, and eₛ=tⱼ with j−i>1, an extra node tₖ^{s} can be constructed for each intermediate time point, i.e., for each k=i+1, . . . , j−1. In FIG. 4, the node labeled “19:00A” is an example of such a node for an intermediate time point.

The set of edges, all with capacity one, is defined as follows. First, there is an edge (tᵢ,tᵢ₊₁) for all i=1, . . . , n−1, as before with cost zero. Secondly, consider each TV program sεS, with time points bₛ=tᵢ and eₛ=tⱼ, and one again distinguishes two cases, as follows.

If j−i=1, then add an edge (bₛ, eₛ) with cost −vₛ.

If j−i>1, then add a number of edges:

$$cost - {v}_{s} \frac{{t}_{i + 1} - {t}_{i}}{{e}_{s} - {b}_{s}} ,$$

(i) an edge (tᵢ,tᵢ₊₁^{s}) with

(ii) an edge (tₖ^{s}, tₖ₊₁^{s}) for each k=i+1, . . . , j−2 with

$$cost - {v}_{s} \frac{{t}_{k + 1} - {t}_{k}}{{e}_{s} - {b}_{s}} ,$$

(iii) an edge (tⱼ₋₁^{s}, tⱼ) with

$$cost - {v}_{s} \frac{{t}_{j} - {t}_{j - 1}}{{e}_{s} - {b}_{s}} ,$$

(iv) an edge (tₖ^{s}, tₖ^{s}) for each k=i+1, . . . , j−1 with cost cₛ^{fe}, and

(v) an edge (tₖ, tₖ^{s}) for each k=i+1, . . . , j−1 with cost cₛ^{sl}.

Now PPSP with linear value functions with penalties corresponds to finding a minimum-cost flow of one from source to sink in this graph. Again, multiple parts per TV program may be selected, as with the graph of FIG. 3.

For the correspondence between a flow in the graph and a selection of partial TV programs, consider again the example in FIG. 4. TV program A is completely selected if both edge (18:00, 19:00A) and edge (19:00A, 19:30) carry a flow of one. In this situation the edges (19:00, 19:00A) and (19:00A, 19:00) will not carry a flow. The cost of the flow over these former two edges exactly add up to −v_{A}, corresponding to a value v_{A} for the selection of TV program A. Only selecting the first part of A corresponds to a flow of one through edges (18:00, 19:00A) and (19:00A, 19:00), resulting in a cost −2v_{A}/3+c_{A}^{fe}, i.e., a value 2v_{A}/3 for this first part and a penalty c_{A}^{fe} for finishing A early. Only selecting the second part of A corresponds to a flow of one through edges (19:00, 19:00A) and (19:00A, 19:30), resulting in a cost −v_{A}/3+c_{A}^{sl}, i.e., a value v_{A}/3 for this second part and a penalty c_{A}^{sl} for starting A late.

The number of nodes and edges in the extended graph is still polynomially bounded in the size of the instance, as the total number of nodes is O(|S|n), and the number of edges is

O(n+|S|+|S|n)=O(|S|n).

A second embodiment selects partial TV programs with multiple tuners: A next extension of PSP is to allow multiple tuners as well as partial TV programs, as given by the next definition.

Definition 4 (Multi-tuner partial program selection problem (MPPSP)). Given is a set S of TV programs, and for each program s a begin time bₛ and end time eₛ. Furthermore, for each program s a value function vₛ is given, and a number m of tuners is given. The problem is to determine for each TV program sεS a (possibly empty) set Iₛ={[l₁,r), . . . , [lₖ_{ₛ}, rₖ_{ₛ})} of intervals during which to watch or record it, with bₛ≦l₁<r₁<l₂<r₂< . . . <lₖ_{ₛ}<rₖ_{ₛ}≦eₛ, such that the TV programs can be received in the selected intervals with m tuners, i.e., for all times x we have

|{[l,r)εIₛ|sεŜl≦x<r}|≦m.

and such that the total value of the selected intervals, given by

$${\sum }_{s ∈ S} {\sum }_{[ l , r ) ∈ {I}_{s}} {v}_{s} ( l , r ) ,$$

is maximized.

Unfortunately, a straightforward application of the extended graph for convex value functions with adapted capacities, as discussed above, does not work. The reason for this is that in that extended graph one may select several parts of the same TV program to be received in parallel. For instance, for the example of FIG. 3 with three tuners the resulting solution might be to receive TV program I and partial TV programs I₁ and I₅, meaning that the part of TV program I from 19:00-19:30 will be received three times.

For linear value functions with penalties, nevertheless, the graph as shown in FIG. 4 applies. The only modification is again that we have to increase the capacities of the edges (tᵢ,tᵢ₊₁) from 1 into m, and a minimum-cost flow of m from source to sink must be found. The reason this graph can be reused is that for each TV program and each time interval there is at most one edge covering it, so no part is received more than once.

Referring now to FIG. 5, an apparatus (500) is shown for selecting a set S (501.1) from a memory module (501) storing a given set of N≦1 TV programs s, each having a begin time bₛ, an end time eₛ, and a viewer-preference function vₛ, the latter being provided by the viewer or a recommender. For one tuner the value function is selected from the group consisting of convex functions and linear with penalties. For more than one tuner, the value function is linear with penalties. The apparatus further comprises a processor module (502) that executes or itself further comprises a minimum cost network algorithm module for selecting an optimal set S′⊂S including partial TV programs to be received and possibly recorded by M≧1 tuners (503).

Referring now to FIG. 6, a system (400) comprising the apparatus of FIG. 5 to select an optimal set of TV programs that includes partial TV programs for a given time interval and given viewer preferences, and a TV set wherein an incoming broadcast signal (304) is scanned for TV programs selected by the apparatus of FIG. 5 (300) and selected partial TV programs are recorded by the tuners (303) and displayed on the TV (401) all being controlled/executed by processor (302).

While the preferred embodiments of the present invention have been illustrated and described, it will be understood by those skilled in the art, the system, apparatus and method for selecting a best set of partial TV programs based on maximizing viewer satisfaction expressed as a function of viewer preferences, as described herein, are illustrative and various changes and modifications may be made and equivalents may be substituted for elements thereof without departing from the true scope of the present invention. In addition, many modifications may be made to adapt the teachings of the present invention to a particular situation, e.g., various optimization algorithms, without departing from its central scope. Therefore, it is intended that the present invention not be limited to the particular embodiments disclosed as the best mode contemplated for carrying out the present invention, but that the present invention include all embodiments falling with the scope of the appended claims.

1. A method for selecting a set of partial TV programs preferred by a viewer to be received in a given time period [b, e] beginning at time b and ending at time e, comprising the steps of:
specifying a set S including a number N>1 preferred TV programs s each having a value function vₛ, begin time bₛ, an end time eₛ;
providing M≦1 tuners (503) to receive and record a partial TV program s of S;
constructing a directed graph G=(V, E) comprising a set of nodes V and a set of edges E having associated costs and capacities, said nodes and edges being arranged in increasing time order from a start node at time 0 to a sink node at time ∞ and for each sεS including a node pair for at least one subpart of s and an edge between each included node pair, wherein for at least one program s the at least one subpart of s is not s;
applying a minimum-cost network flow algorithm (502.1) to the directed graph G to determine an optimal subset S′ ⊂S such that the value function vₛ(l, r) over the subset S′ is maximized and the partial TV programs in S′ are received by the M≧1 tuners without conflicts during the time period [b, e].

2. The method of claim 1, wherein the applying step further comprises the step of the pre-determined function computing the linear sum of the value function v₅ over the subset S′.

3. The method of claim 1, wherein the specifying step further comprises the step of the viewer or a recommender specifying the set S.

4. The method according to claim 1, wherein the constructing step further comprises the steps of:
creating a timeline of zero cost edges each having capacity M, from the start node to the sink node by placing thereon a node pair for parts of s
creating an edge between each node pair of each part of sεS having an associated cost determined by the value function vₛ and a capacity 1.

5. The method of claim 4, wherein the applying step further comprises the step of computing the linear sum of the value function v, over the subset S′.

6. The method of claim 5, wherein the specifying step further comprises the step of the viewer or a recommender specifying the set S.

7. The method of claim 6, wherein:
M=1;
the value function is selected from the group consisting of
i. convex functions, and
ii. pre-determined linear value functions having penalties for finishing a show early and starting a show late; and
wherein the constructing step further comprises the steps of:
a. for each part of s, constructing an extra node and extra zero cost edges having capacity 1 in the timeline of zero cost edges and
b. adding at least one additional edge for each part of s, each additional edge having a cost assigned in accordance with the value function.

8. The method of claim 7, wherein when the value function is linear the adding step further comprises the step of for a TV program sεS, with time points bₛ=tᵢ and eₛ=tⱼ,
b.1 if j−i=1, then adding an edge (bₛ, eₛ) with cost −vₛ.
b.2 if j−i>1, then adding a number of edges:
b.2.1 an edge (tᵢ,tₜ₊₁^{s}) with
$$cost - {v}_{s} \frac{{t}_{i + 1} - {t}_{i}}{{e}_{s} - {b}_{s}} ,$$
b.2.2 an edge (tₖ^{s},tₖ₊1^{s}) for each k=i+1, . . . , j−2 with
$$cost - {v}_{s} \frac{{t}_{k + 1} - {t}_{k}}{{e}_{s} - {b}_{s}} ,$$
b.2.3 an edge (tⱼ₋₁^{s},tⱼ) with
$$cost - {v}_{s} \frac{{t}_{j} - {t}_{j - 1}}{{e}_{s} - {b}_{s}} ,$$
b.2.4 an edge (tₖ^{s}, tₖ) for each k=i+1, . . . , j−1 with cost cₛ^{fe}, and
b.2.5 an edge (tₖ,tₖ^{s}) for each k=i+1 . . . , j−1 with cost cₛ^{sl},
wherein, fe=‘finished early’ and sl=‘started late’.

9. The method of claim 6, wherein:
M>1; and
the value function is a linear value function having penalties for finishing a show early and starting a show late.

10. The method of claim 9, wherein the constructing step further comprises the steps of:
for each part of s, including an extra node and extra zero cost edges having capacity 1 in the timeline of zero cost edges, and adding at least one additional edge for each part of s having a cost assigned in accordance with a pre-determined penalty function of the value function.

11. The method of claim 10, wherein the adding step further comprises the steps of for a TV program sεS, with time points bₛ=tᵢ and eₛ=tⱼ,
if j−i=1, then adding an edge (bₑ, e_{S}) with cost −vₛ;
if j−i>1, then adding a number of edges:
(i) an edge (tᵢ,tₜ₊₁^{s}) with
$$cost - {v}_{s} \frac{{t}_{i + 1} - {t}_{i}}{{e}_{s} - {b}_{s}} ,$$
(ii) an edge (tₖ^{s},tₖ₊₁^{s}) for each k=i+1, . . . , j−2 with
$$cost - {v}_{s} \frac{{t}_{k + 1} - {t}_{k}}{{e}_{s} - {b}_{s}} ,$$
(iii) an edge (tⱼ₋₁^{s},tⱼ) with
$$cost - {v}_{s} \frac{{t}_{j} - {t}_{j - 1}}{{e}_{s} - {b}_{s}} ,$$
(iv) an edge (tₖ^{s},tₖ) for each k=i+1, . . . , j−1 with cost cₛ^{sl}, and
(v) an edge (tₖ, tₖ^{s}) for each k=i+1 . . . j−1 with cost cₛ^{sl},
wherein, fe=‘finished early’ and sl=‘started late’.

12. An apparatus (500) for reception and delivery of viewer-preferred TV programs (504) during a given time period [b, e] beginning at time b and ending at time e, comprising:
a memory module (501) containing a set S of a number n≧1 of viewer-preferred TV programs numbered s=1, . . . , n each having a begin time bₛ, an end time eₛ, and a value function vₛ;
a number m≧1 of tuners (503) to receive (and record) a TV program s of S;
a processor module (502) configured to execute a partial program model formulation module to formulate and store in the memory (501) a partial program model of the set S and generate a directed graph G of partial TV programs therefrom, and a minimum-cost network algorithm module that accesses the memory to select a subset of the generated graph G of partial TV programs to receive and record, such that the selected subset of partial TV programs can be received by the plurality of tuners without conflicts within the time interval [b, e], and the total of the value function over the subset is maximized.

13. A system (600) for scheduling a TV viewing session of partial TV programs preferred by a viewer, comprising:
a TV set (601) for viewing a TV program;
an apparatus (500) according to claim 12 for selecting and receiving a viewer's preferred TV programs and displaying on the TV (400) at least a part of the received TV programs during a predetermined time span [b, e] having a beginning time b and an ending time e.

14. An apparatus (500) for reception and delivery of viewer-preferred TV programs (504) during a given time period [b, e] beginning at time b and ending at time e, comprising:
a memory module (501) containing data describing a set S of a number n≧1 of viewer-preferred TV programs s each having a begin time bₛ, an end time eₛ, and a value function vₛ;
a set of M≧1 tuners (503) to receive (and record) a partial TV program s of S;
a processor module (502) configured to execute the method of claim 8 using the data describing set S contained in the memory module (301) and the set of tuners.

15. An apparatus (500) for reception and delivery of viewer-preferred partial TV programs (504) during a given time period [b, e] beginning at time b and ending at time e, comprising:
a memory module (501) containing data describing a set S of a number n≧1 of viewer-preferred TV programs s each having a begin time bₛ, an end time eₛ, and a value function vₛ;
a set of M>1 tuners (503) to receive (and record) a partial TV program s of S;
a processor module (502) configured to execute the method of claim 11 using the data describing set S contained in the memory module (501) and the set of tuners.

16. A system (600) for scheduling a TV viewing session of partial programs preferred by a viewer, comprising:
a TV set (601) for viewing a TV program;
an apparatus (500) according to claim 14 for selecting and receiving a viewer's preferred partial TV programs and displaying on the TV (400) at least a part of the received TV programs during a predetermined time span [b, e] having a beginning time b and an ending time e.

17. A system (600) for scheduling a TV viewing session of partial programs preferred by a viewer, comprising:
a TV set (601) for viewing a TV program;
an apparatus (500) according to claim 15 for selecting and receiving a viewer's preferred partial TV programs and displaying on the TV (400) at least a part of the received TV programs during a predetermined time span [b, e] having a beginning time b and an ending time e.

18. A computer program stored in a memory (501), comprising an executable module to perform the method of claim 8 (502.1-3) and a data module (501.1) including a set S as input to the method of claim 8 comprising a number n≧1 of preferred partial TV programs numbered s each having a begin time bₛ, an end time eₛ, a value function vₛ.

19. A computer program stored in a memory (501), comprising an executable module to perform the method of claim 11 (502.1-3) and a data module (501.1) including a set S as input to the method of claim 11 comprising a number n≧1 of preferred partial TV programs numbered s each having a begin time bₛ, an end time eₛ, a value function vₛ.
